(19) United States
(12) Patent Application Publication
(10) Pub. No.: US 2011/0137878 A1
(43) Pub. Date: Jun. 9, 2011

(54) Data Consistency Validation

(75) Inventors: Thomas Werner, Baden (CH); Philip Meier, Dietikon (CH); Claus Vetter, Buchs (CH); Martin Naedele, Zurich (CH)

(73) Assignee: ABB Research Ltd., Zürich (CH)

(21) Appl. No.: 10/593,094

(22) PCT Filed: Mar. 17, 2004
(86) PCT No.: PCT/CH2004/000157

§ 371 Date: Oct. 17, 2007

(51) Int. Cl. G06F 7/00; G06F 17/00

(52) U.S. Cl. 707/697

(57) ABSTRACT

An entity to be validated for consistency is loaded into the buffer of the consistency service, a signal to verify the existence of a specific data set of an IT system is then sent by the consistency service to the IT system holding the entity to be validated for consistency, and the consistency validating information is stored in the output means, said consistency validating information depending on the signal being sent back to the consistency service.

The consistency of data stored in various IT systems is checked prior to attempting to access it. Errors by calling a service or functionality that would require access to data that is not available or that is inconsistent can therefore be avoided.

### FIELD OF THE INVENTION

The invention relates to the field of utility automation.

It relates to a method for validating consistency of entities stored in data sets of a multitude of different IT systems used for operating utility automation assets.

### BACKGROUND OF THE INVENTION

With the deregulation of energy markets, focus in utilities shifts towards optimizing the internal business processes. On the IT system side, navigation between, synchronization and retrieval of information stored in the various data sources in operation (e.g. SCADA—supervisory control and data acquisition, CMMS—computerized maintenance management systems, GIS—geographic information system) is a challenge.

All applications work on the same “world view”—physical assets in utility operations, such as stations, lines, transformers, breakers, regions and areas. These assets are modeled in the various applications and carry specific attributes with them. However, a consolidated access to this information is cumbersome and maintenance efforts for the data stores are huge. Examples here are network modifications, such as commissioning or disposals of assets, which subsequently imply changes in the IT application data sets.

To overcome the challenges of interoperability between the various systems, integration applications are being developed. One example is the cross-application navigation between the graphical user interfaces (GUI) of participating applications in the same context. Another example is the uniform data access independent of underlying source applications.

As soon as relationships between entities in different data sources are defined, consistency of those relationships becomes a relevant issue for applications that rely on those relationships.

Today, a number of IT systems are in operation in utilities, with which the different facets of utility operations are managed: a SCADA system carries an electrical view on assets (electrical network) in order to open/close breakers, monitor voltages, currents or capacity limits. CMMS, such as SAP PM and GIS, such as ESRI, are used for maintenance management for physical assets. The first one contains (active and archived) work reports, new work orders, allows dispatching crews, whereas GIS is used to optimize maintenance operations through the spatial view on the assets.

Each system comes with specific tools and applications, which allow users to modify the underlying data sets, both for an initial setup and continuous updates. Furthermore, the applications have different access technologies to their data stores: SQL, OPC, file import/export, and others.

Since the responsibility for the systems lies in the corresponding departments (SCADA—operations, CMMS/GIS—maintenance), changes to the data set of those systems are done through a manual process, e.g., using paper, phone, or e-mail between responsible persons in the departments. This process is error-prone, and leaves the utilities with incorrect data sets with their applications.

### DESCRIPTION OF THE INVENTION

It is an object of the invention to reduce malfunctions of utility IT systems due to inconsistent data.

This is achieved with a method for validating consistency of entities stored in data sets of a multitude of different IT systems according to claim 1.

With the inventive method, the consistency of data stored in IT systems can be checked prior to attempting to access it. This allows offering a certain service or functionality of an application only if the required data is consistently available. Errors by calling a service or functionality that would require access to data that is not available or that is inconsistent are therefore avoided.

Maintenance of the data structure is simplified, since the consistency check easily allows identifying and resolving missing or conflicting data.

Existing applications are not to be modified since a polling mechanism through adapters is used to acquire the needed information from the applications.

Since the relationships are stored in an external database, the consistency check can be used for several applications, such as navigation or data access.

### BRIEF DESCRIPTION OF THE DRAWINGS

The invention will be explained in more detail in the following text with reference to the attached drawings, in which:

FIG. 1 shows the reference modeling of a ‘real world object’,

FIG. 2 shows the setup of the consistency validating system, and

FIG. 3 shows a detailed block diagram of the functionality of the inventive system shown in FIG. 2

### DETAILED DESCRIPTION OF PREFERRED EMBODIMENTS

Consistency of data sets in heterogeneous data sources is validated according to the inventive method, assuming that the various entities are related in the “real world” despite their different modelling in the respective applications. Stations, lines, transformers or breakers are exemplary entities from the field of utilities. These “real-world” entities exist as modeled entities in all of the above mentioned applications (e.g. SCADA, CMMS, GIS).

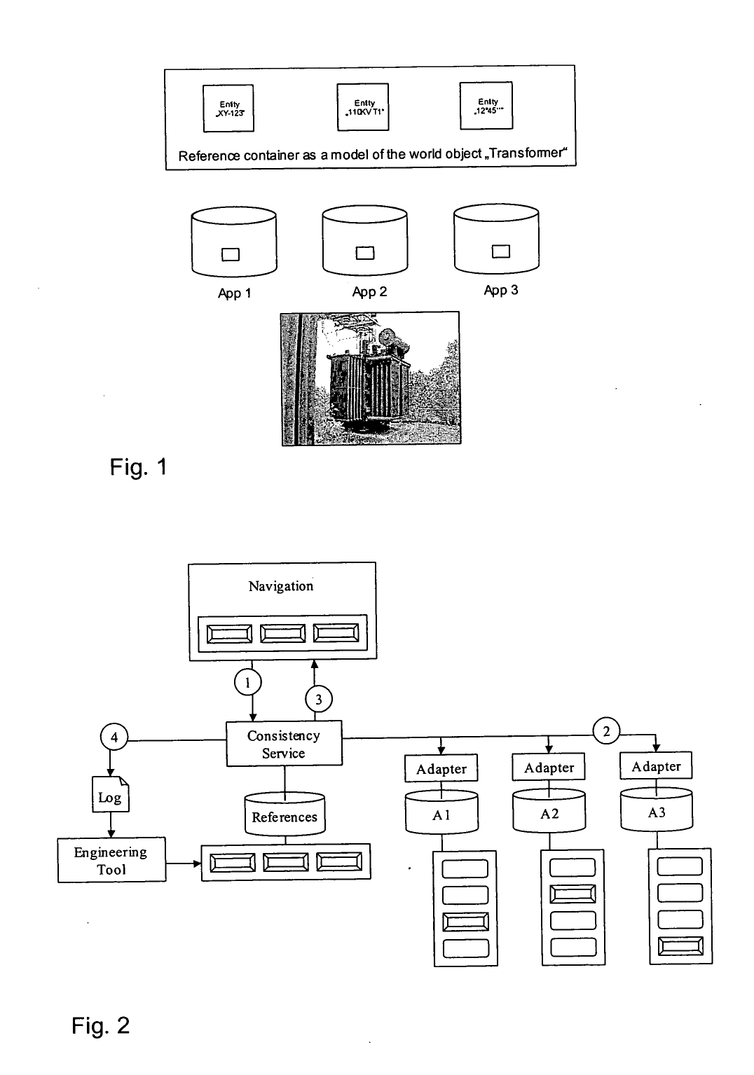

The relationship between entities in the various applications is modeled according to FIG. 1 and stored in any kind of reference model, which acts as a container for the references of the same “real-world”-object in the different applications. Even though the relationship between the entities is most likely on the same “real word” asset, the transformer shown in the picture of FIG. 1, it is also possible that these relationships are defined freely by the user of any one of the various IT systems.

If, e.g. the navigation from the GIS object ‘pole’ to the SCADA object ‘line’ is desired, the presented approach will allow a definition of such a relationship.

The relationships of the entities stored in the different systems are engineered in an initial phase and are stored in external data storage. If modifications are done in one of the source system databases (e.g. SCADA), the relationships may become invalid, and must be marked for further editing or changes in a subsequent engineering process.

The inventive system knows about the relationships of entities in the data stores of the participating applications and provides a service which allows performing a consistency check either before a functionality is triggered, used by applications such as navigation, or continuously on the relations stored in the external data store.

For each application which holds data sets (CMMS: SAP, GIS: ESRI, SCADA: ABB Spider), an adapter manages the specifics to communicate against the application and hide access to the application APIs towards this service. The adapter provides functionality to check for availability of the target application and the status of the reference.

Entities and the reference container itself for which an inconsistency has been detected, are marked as critical.

This allows to include those critical entities and connections in an update of the engineering process or to provide a direct feedback to a calling application whether specific functionality is available on the selected reference of entities or not (e.g., view only, edit)

The setup of a validating system for consistency is shown in FIG. 2. An external storage holds a ‘world view’ of entities in different IT systems. If access to a certain entity of a specific IT system is required, that entity can be addressed and details about the entity can be taken from the IT system.

There are adapters to each IT system that allow pinging the data sets of the systems. A signal sent to the IT systems to verify the existence of a specific data set is sent back by the adapters if the specific data set exists. Otherwise no signal is sent, thus indicating that the data set is missing.

The inventive system comprises a consistency service with an input buffer, output means and communication means to communicate with the adapters of the various IT systems.

An external application registers at the consistency service to be notified on consistency feedback. This calling application can place an entity for which the consistency must be ensured in the buffer, and will get notified as soon as the entity has been processed by the service.

In another approach, a batch application can place a set of entities, or relationships, as defined in the external data store, into the buffer for cyclic checks. No callbacks from the service are triggered. Instead, inconsistent data sets are logged by the service in order to include those in a re-engineering process.

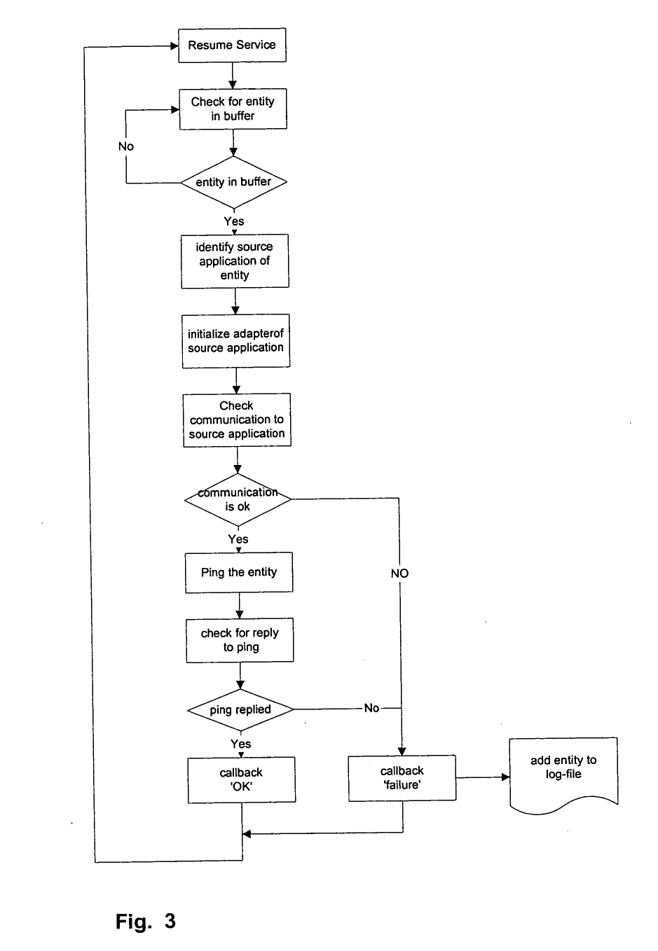

The consistency service fulfills the following functionality as shown in detail in the block diagram of FIG. 3:

As soon as there is an element in the input buffer, that element is taken (1) and the appropriate source application of that element is identified. For that purpose, entities from different source applications are grouped into a reference container during the engineering phase. The entities carry meta-information, such as its local identifier in order to access the entity in the local application, and an application identifier which allows the consistency service to direct any requests related to that entity to the corresponding adapter. The adapter of the IT system to be checked is initialized. Then the communication to the source application is checked by sending a service request (e.g. ping the machine the application is residing on, with defined return values: system: UP, entity: EXISTS) to the source applications. If the communication is properly working, the entity to be verified is pinged by sending out a signal as described above (2). If the entity does exist and a return signal is sent back accordingly, an OK can be loaded into the output means of the consistency service (3). The calling application gets the OK and knows that the requested entity is available. If the entity does not exist, the output means and the calling application will get a failure signal. In addition, a log file will be updated by adding details about the non-consistent entity (4).

1. Method for validating consistency of entities stored in data sets of a multitude of different IT systems,
whereas a consistency service comprises
an input buffer in which an entity to be validated for consistency can be placed,
output means in which the result of the consistency validation can be stored and
communication means to communicate with the different IT systems,
whereas an adapter for each of the IT systems allows communication between the consistency service and the IT systems, such that a signal sent by the consistency service to verify the existence of a specific data set of an IT system can be sent back to the consistency service if that specific data set exists, and
whereas a storage device holds references to the entity in the data sets of the various IT systems such that the entity in a specific IT system can be addressed, said method comprising the following steps:
loading the entity to be validated for consistency into the buffer of the consistency service,
the consistency service sending a signal to verify the existence of a specific data set of an IT system to the IT system holding the entity to be validated for consistency, storing a consistency validating information in the output means, said consistency validating information depending on the signal being sent back to the consistency service.

2. Method as in claim 1, further comprising the following step:
logging failure of consistency validation if no signal is being sent back to the consistency service, by adding the entity, which was to be validated for consistency, and the IT system, which was not replying to the signal, to a log file.

3. Method as in claim 1, further comprising the following step:
the consistency service checking the communication to the IT system holding the data set to be verified prior to sending the signal to verify the existence of the specific data set of that IT system.

4. Method as in claim 1, further comprising the following steps:
loading a multitude of entities to be validated for consistency into the buffer of the consistency service, and
the consistency, service successively processing the entities to be validated for consistency, sending out signals and storing consistency validating information in the output means.

5. A computer program product loadable into an internal memory of a digital computer, comprising computer program code means to make, when said program is loaded in the computer, the computer execute the method of claim 1.
